(19) United States
(12) Patent Application Publication
(10) Pub. No.: US 2023/0299598 A1
(43) Pub. Date: Sep. 21, 2023

(54) MAGNETICALLY SECURED BATTERY CHARGER

(71) Applicant: APEX BRANDS, INC., Apex, NC (US)

(72) Inventors: Scott Bublitz, Denver, NC (US); Pratik Bendale, Charlotte, NC (US); Eric Van Fossen, Huntersville, NC (US)

(21) Appl. No.: 18/010,909

(22) PCT Filed: May 21, 2021
(86) PCT No.: PCT/US2021/033615

§ 371 Date: Dec. 16, 2022

Related U.S. Application Data
(60) Provisional application No. 63/051,068, filed on Jul. 13, 2020.

(51) Int. Cl. H02J 7/00

(52) U.S. Cl. CPC H02J 7/0042

(57) ABSTRACT

A battery charger includes a housing with a base and battery charging electronics disposed within the housing. The battery charger also includes a first magnet disposed adjacent to the base on an internal side of the base, and a second magnet disposed adjacent to the base on the internal side of the base. Magnetic fields of the first magnet and the second magnet extend from the housing and away from the base to magnetically attract the base of the housing to a ferromagnetic surface to magnetically secure the battery charger to the ferromagnetic surface.

### TECHNICAL FIELD

Example embodiments generally relate to power tool accessories, and in particular to battery charging devices.

### BACKGROUND

Work benches and other construction environments can readily become cluttered and often offer less space than is needed for a given project. As such, work space may be at a premium and an ability conveniently place tools and other accessories becomes increasing valuable. As such, the area relating to tool organization and storage continues to evolve. The goal is often to maximize work space while having tools stored in easily accessible locations. Solutions for hands tools, such as, peg boards and other hanging solutions have become common. However, many electronic items, like battery chargers, which can be bulky, are generally still placed on a work surface and take up valuable work space. Also, when working on a project at a remote location, placement of a battery charger can be difficult when a table surface or other work surface is not available due to, for example, the reach of power cords and the unavailability of horizontal surfaces upon which the battery charger may be placed. As such, in some instances, a battery charger may have to be placed inconveniently on ground or on the floor, which increases the likelihood of the battery charger becoming damaged due to reduced visibility and exposure to dirt and the elements. Accordingly, it would be beneficial to increase the available options for placement a battery charger in a common workspace or at a specific work locations.

### BRIEF SUMMARY OF SOME EXAMPLES

According to some example embodiments, a battery charger is provided. The battery charger may comprise a housing, and the housing may comprise a base. The battery charger may further comprise battery charging electronics disposed within the housing. Additionally, the battery charger may comprise a first magnet disposed adjacent to the base on an internal side of the base and a second magnet disposed adjacent to the base on the internal side of the base. Magnetic fields of the first magnet and the second magnet may extend from the housing and away from the base to magnetically attract the base of the housing to a ferromagnetic surface to magnetically secure the battery charger to the ferromagnetic surface.

According to some example embodiments, an apparatus is provided that comprises a housing. The housing may comprise a base and a cavity configured to receive a portion of a rechargeable battery that extends into the cavity. The apparatus may further comprise battery charging electronics disposed within the housing. The battery charging electronics may comprise a first contact and a second contact disposed within the cavity and configured to electrically connect with corresponding contacts of the rechargeable battery. Additionally, the apparatus may comprise a first magnet disposed adjacent to the base on an internal side of the base and a second magnet disposed adjacent to the base on the internal side of the base. Magnetic fields of the first magnet and the second magnet may extend from the housing and away from the base to magnetically attract the base to a ferromagnetic surface to magnetically secure the apparatus to the ferromagnetic surface.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates an example block diagram of an apparatus in the form of a battery charger according to some example embodiments;

FIG. 2 illustrates a physical embodiment of the battery charger of FIG. 1 shown in a perspective view according to some example embodiments;

FIG. 3 illustrates a bottom view of the battery charger according to some example embodiments;

FIG. 4 illustrates the battery charger secured to a wall via magnetic attraction to a surface according to some example embodiments;

FIG. 5 illustrates an internal view into the housing of the battery charger and the securing assembly for the magnets according to some example embodiments; and

FIG. 6 illustrates a cross-section of a foot and a magnet protrusion in engagement with a surface according to some example embodiments;

FIG. 7 illustrates a cross-section of a foot and a magnet protrusion not in engagement with a surface according to some example embodiments; and

FIG. 8 illustrates an example application of a battery charger to a side of a tool box, according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. As used herein, operable coupling should be understood to relate to direct or indirect connection that, in either case, enables functional interconnection of components that are operably coupled to each other.

According to various example embodiments, an apparatus that comprises a battery charger that may be secured to a surface via magnetic attraction is provided. The apparatus may comprise a housing with a base and a battery engagement side of the housing that, for example, may be disposed opposite the base. The base may be side of the housing that is closest to and configured to interface with a surface, e.g., table top, side of a tool box, or the like, when the apparatus is properly positioned on the surface, while the battery engagement side may be the side of the housing that receives or otherwise engages with a rechargeable battery. One or more magnets may be disposed at or about the base of the apparatus such that the magnetic fields of the magnets interact with a ferromagnetic surface (i.e., a surface comprising materials that can be attracted to a magnetic field, such as, steel, iron, etc.) to physically secure the apparatus to the ferromagnetic surface. According to some example embodiments, the magnets may be disposed within cavities formed by protrusions in the base that permit the magnets to be disposed relatively close to the ferromagnetic surface. The battery charger may also comprise a plurality of feet that extend from the base and physically contact the surface upon which the apparatus is placed. Some or all of the feet may have pads secured to a bottom of the respective foot. The pads may have a high-friction surface to inhibit or prevent the apparatus from sliding on a surface when secured via the attractive magnetic forces. Additionally, the pads may be compressible such that, when compressed, the protrusions that house the magnets may come into contact with the surface upon which the apparatus is placed to maximize the frictional forces generated by the pads and the attractive forces between the magnets and the ferromagnetic surface.

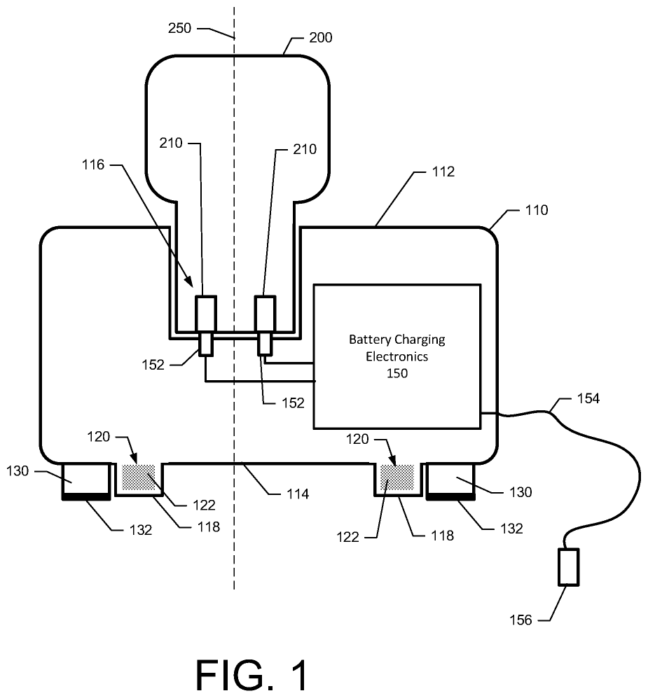

In this regard, FIG. 1 illustrates an example block diagram of an apparatus in the form of a battery charger 100. The battery charger 100 may comprise a housing 110 and battery charging electronics 150. The housing 110 may be formed of, for example, molded plastic, and the housing 110 may have a battery engagement side 112 and a base 114. The battery engagement side 112 may be configured to be a side of the housing 110 that engages with a rechargeable battery 200 during charging. In this regard, the battery engagement side 112 may, according to some example embodiments, include a cavity 116 that may be a receptacle for receiving at least a portion of the rechargeable battery 200 (e.g., such as a portion that includes battery contacts for forming an electrical connection with the battery charger 100). According to some example embodiments, the cavity 116 may include mechanical engagement features (e.g., slots, grooves, blades, slides, teeth, clips, voids, etc.) configured to engage with corresponding features on the exterior of the rechargeable battery 200 to physically maintain the rechargeable battery 200 within the cavity 116.

Additionally, battery charger 100 may also include battery charging electronics 150. The battery charging electronics 150 may be configured to electrically interface with the rechargeable battery 200 to charge the rechargeable battery 200. To electrically interface with the rechargeable battery 200, the battery charger 100 may include charger contacts 152 (e.g., formed of a metal) that may be disposed within the cavity 116. Further, the rechargeable battery 200 may include battery contacts 210 that may be positioned or keyed to facilitate electrical engagement between the charger contacts 152 and the battery contacts 210 when the rechargeable battery 200 is inserted into the cavity 116.

The battery charging electronics 150 may include components such as a switching power supply to convert alternating current from a power source into direct current for use in charging the rechargeable battery 200. Further, the battery charging electronics 150 may include a battery management system (BMS) that may be implemented by components comprising a hardware configured processor (e.g., field programmable gate array (FPGA), application specific integrated circuit (ASIC), or the like) or a software configured processor (e.g., a microprocessor configured via the execution of instructions stored in a non-transitory memory device). The BMS may be configured to monitor the charging of the rechargeable battery 200 to discontinue charging when an defined charge level threshold is reached, and provide outputs (e.g., lights) that indicate the same. The BMS may also monitor other status indicators of the rechargeable battery 200 such as temperature and resistance across the battery contacts 210 of the rechargeable battery 200. In this regard, the BMS may be configured to discontinue charging if a temperature of the rechargeable battery 200 reaches a threshold temperature or if a resistance across the battery contacts 210 indicate a short or an open circuit.

Power may be provided to the battery charging electronics 150 via a power cord 154. The power cord 154 may be configured to deliver power from, for example, a power outlet in a home or building to the battery charging electronics 150. The power cord 154 may be include a plug 156 that may have prongs configured to be inserted into a power outlet to make an electrical connection to a power source for the battery charging electronics 150.

The base 114 of the housing 110 may include features for interfacing with a surface upon which the battery charger 100 may be placed. In this regard, a plurality of feet 130 may be extend from, or be disposed on, the base 114 and extend away from the base 114. According to some example embodiments, the feet 130 may be disposed adjacent to an periphery of the base 114 and spaced away from the center of the battery charger 100 to increase or maximize stabilization of the battery charger 100 on a surface. According to some example embodiments, some or all of the feet 130 may include a pad 132 disposed at a distal end of a foot 130. The pad 132 may, according to some example embodiments, perform two functions. First, the pad 132 may have a high coefficient of friction to prevent the battery charger 100 from sliding on an surface. In this regard, the pad 132 may be comprised, for example, of a rubber. Second, the pad 132 may be compressible (i.e., formed of a compressible material such as a rubber, foam, or the like). The pad 132 may be affixed to the distal end of the foot 130 via an adhesive or a physical connection (e.g., a protruding flexible tab or button that inserts into an opening the distal end of the foot 130). According to some example embodiments, the pads 132 may be overmolded on the feet 130.

According to some example embodiments, the battery charger 100 may include magnets 122 that are disposed adjacent to the base 114. The magnets 122 may be disposed internal to the housing 110 near the base 114. Further, in some example embodiments, the base 114 may include a number of protrusions 118 that extend toward the surface upon which the battery charger 100 is placed. The protrusions 118 may form an internal magnet cavity 120 and a magnet 122 may be disposed in the internal magnet cavity 120 of the protrusion 118 in the base 114. According to some example embodiments, the protrusion 118 may be configured to house the magnets 122 to permit the magnets 122 to be adjacent to the surface upon which the battery charger 100 is placed. By placing the magnets 122 close to the surface, the magnetic field that interacts with the surface, when the surface is a ferromagnetic surface, may be of a higher field strength, since field strength decreases as distance from the surface increases. As such, according to some example embodiments, the protrusions 118 may extend to be contact with the surface, with the feet 130 also being in contact with the surface.

Although battery charger 100 is shown with two magnets 122, any number of magnets 122 may be used. Further, the magnets 122 may be formed of any type of magnetic material. All magnets 122 may be same size and shape, or the magnets 122 may be sized or shaped differently, for example, based on the position of the magnets relative to the weight distribution of the battery charger 100, particularly when a rechargeable battery 200 installed in the battery charger 100. In this regard, the magnets 122 may have field strengths (collectively) that are sufficient to hold the battery charger 100 and a rechargeable battery 200 on, for example, a ferromagnetic surface that is a vertical wall. For example, such a wall may be a side of a tool box, an external surface of a work vehicle, or the like. According to some example embodiments, magnets 122 may be formed as rare-earth magnets, such as neodymium magnets, samarium-cobalt magnets, or the like. The magnets 122 may be oriented such that a maximum magnetic field strength is directed toward the surface upon which the battery charger 100 is to be placed.

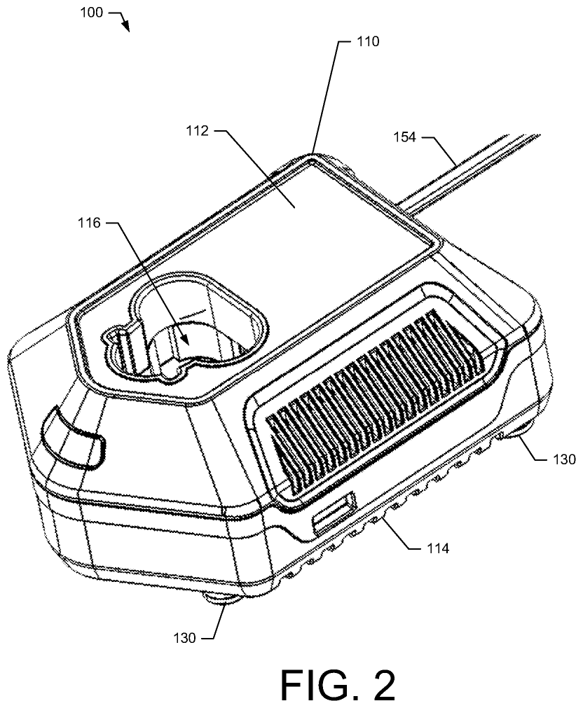

Having described the battery charger 100 based on the functional block diagram of FIG. 1, FIG. 2 illustrates a physical embodiment of the battery charger 100 shown in a perspective view. As can be seen, the battery charger 100 may include the housing 110, that may form an external casing for the battery charger 100 having various sides. In this regard, the housing 110 may include a battery engagement side 112. A cavity 116 for receiving at least a portion of the rechargeable battery 200 may be disposed on the battery engagement side 112. As shown in FIG. 2, the cavity 116 may include, for example, grooves that are configured to engage with a corresponding blade on the external housing of the rechargeable battery 200. Additionally, the battery charger 100 may include a base 114 portion of the housing 110 that is disposed, for example, opposite the battery engagement side 112 of the housing 110. Feet 130 may extend from the base 114 to engage with a surface upon which the battery charger 100 is placed. According to some example embodiments, the power cord 154 may extend from a rear surface of the housing 110.

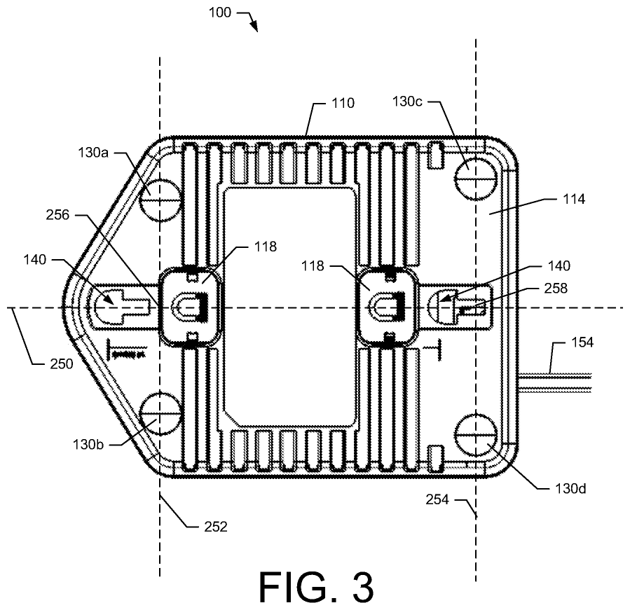

FIG. 3 illustrates a bottom view of the battery charger 100 such that the base 114 is visible. As shown in FIG. 3, the feet 130 may be disposed adjacent to the edges of the base 114 to increase stability. In this regard, the battery charger 100 may include four feet 130 (i.e., feet 130a, 130b, 130c, and 130d). The feet 130a and 130b may be disposed at a front of the base 114 and the feet 130c and 130d may be disposed at a rear of the base 114. As further described below, the front feet and the rear feet may be disposed equidistant from a central plane 250 that can be defined through the battery charger 100. A number of components may be disposed at locations such the components intersect (e.g., centrally intersect) with the central plane 250.

A line 252 that passes through the two front feet, i.e., the first foot 130a and the second foot 130b, may be defined, and a central point 256 on the line 252 may be defined that is equidistant from the first foot 130a and the second foot 130b. Similarly (although separated further apart), a line 254 that passes through the two rear feet, i.e., the third foot 130c and the fourth foot 130d, may be defined, and a central point 258 on the line 254 may be defined that is equidistant from the third foot 130a and the fourth foot 130b. The central plane 250 may be defined as a plane that is orthogonal to the lines 252 and 254 and passes through the central points 254 and the 258. In short, the plane 250 may bisect the housing 110 of the battery charger 100.

According to some example embodiments, the housing 110 may have bilateral symmetry relative to the central plane 250. Further, according to some example embodiments, the battery charger 100 may be designed to have bilateral symmetry with respect to the weight distribution of the battery charger 100, with or without a rechargeable battery 200 installed in the battery charger 100.

According to some example embodiments, the base 114 may include one or more key hole cavities 140. As shown in FIG. 3, two keyhole cavities 140 may be disposed on the base 114, according to some example embodiments. Additionally, according to some example embodiments, the hole cavities 140 may be positioned such that the key hole cavities 140 intersect (e.g., centrally intersect) with the central plane 250. The key hole cavities 140 may comprise a front key hole cavity 140 and a rear keyhole cavity 140. The key hole cavities 140 may be configured to receive a fastener head (e.g., a screw head) to provide for hanging the battery charger 100 on a surface, such as a wall.

Additionally, the protrusions 118 that house the magnets 122 may be disposed on the base 114 as shown in FIG. 3. According to some example embodiments, the protrusions 118 may be positioned such that the protrusions intersect (e.g., centrally intersect) with the central plane 250. The protrusions 118, and thus the magnets 122, may comprise a front protrusion 118 and a rear protrusion 118. Since the both the protrusions 118 and the hole cavities 140 may be aligned to intersect with the central plane 250, the protrusions 118 and the hole cavities 140 may be linearly aligned with each other. Further, according to some example embodiments, the protrusions 118 may be disposed adjacent to the keyhole cavities 140. Additionally, the hole cavities 140 may be externally disposed relative to the protrusions 118, such that both protrusions 118 may be disposed between the hole cavities 140.

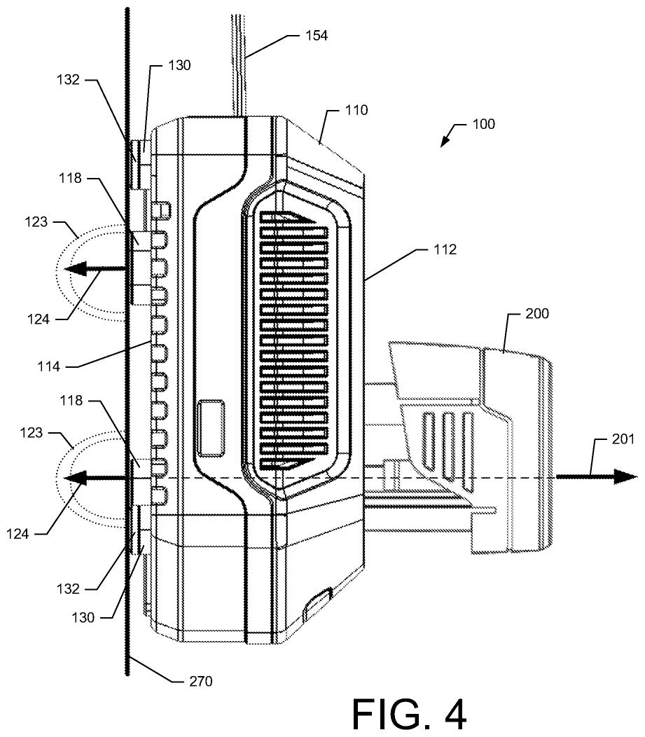

FIG. 4 illustrates the battery charger 100 secured to a vertical wall via magnetic attraction to surface 270. The surface 270 may be a ferromagnetic surface and therefore the magnets 122 of the battery charger 100 may create a magnetic holding or attraction force that holds the battery charger 100 on the surface 270 which, in this example, is a vertical wall.

To secure the battery charger 100 to the surface 270, the magnets 122 (not shown in FIG. 4 but disposed in protrusions 118) may have magnetic fields 123 that interact with the ferromagnetic material of the surface 270 to attract the base 114 of the battery charger 100 to the surface 270. The attraction or magnetic holding forces are indicated by arrows 124 that urge the battery charger 100 toward the surface 270. As a result, the feet 130, and more specifically, the pads 132 of the feet, may be forced into contact with the surface 270. Because the pads 132 may have a high-friction or no-slip surface (e.g., rubber), the pads 132 may assist the magnet 122 in holding the battery charger 100 on the surface 270, which, in this instance, is a vertical surface. The weight of the battery charger 100 would tend to urge the battery charger 100 downward due to gravity, but the frictional forces caused by the pads 132 and pressure applied to the pads 132 by the attraction forces from the magnets 122 may counter this gravitation force and hold the battery charger 100 in place on the vertically oriented surface 270.

As such, the attraction force of the magnets 122 may be sufficient to hold the battery charger 100 with a rechargeable battery 200 installed in the battery charger 100 on a vertical surface, such as surface 270 of FIG. 4. However, the magnets 122 may be also provide sufficient attractive forces beyond merely maintaining the battery charger 100 on the surface 270. In this regard, the attraction forces of the magnets 122 may also be required to maintain the battery charger 100 in place on a vertical surface during removal of the rechargeable battery 200 from the battery charger 100. According to some example embodiments, the housing of the rechargeable battery 200 and the battery contacts 210 may be physically engaged with the battery charger 100 and a therefore a removal force may be required to remove the rechargeable battery 200 from physical engagement with the battery charger 100. Since, according to some example embodiments, the battery engagement side 112 is disposed opposite the base 114, the removal force (indicated by arrow 201) may be oriented in a direction opposite the attraction forces of the magnets 122. As such, the attraction forces may, according to some example embodiments, be required to maintain the battery charger 100 in place on the surface 270 when the removal force 210 is applied by a user during removal of the rechargeable battery 200 from the battery charger 100. According to some example embodiments, to assist with maintaining the battery charger 100 in place during this removal operation, one or more of the magnets 122 may be disposed directly opposite the cavity 116 for receiving the rechargeable battery 200 to reduce or eliminate the generation of a torque or moment on the battery charger 100 relative to the surface 270 during removal of the rechargeable battery 200.

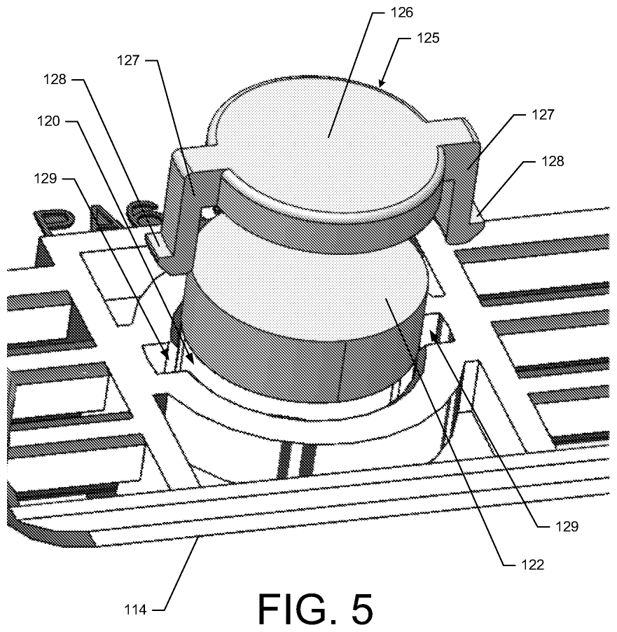

Now referring to FIG. 5, an internal view into housing 110 depicting an exploded view of a magnet securing assembly is provided. In this regard, a view of the internal magnet cavity 120 is provided with the protrusion 118 corresponding with the internal magnet cavity 120 being externally viewable. In this regard, the internal magnet cavity 120 may have a corresponding shape to the shape of the magnet 122 to receive the magnet 122 with a relatively tight fit. As shown in FIG. 5, the magnet 122 may be cylindrically shaped and the internal magnet cavity 120 may have a corresponding cylindrical shape. Accordingly, the magnet 122 may be installed into the internal magnet cavity 120.

To secure the magnet 122 within the internal magnet cavity 120, a clip 125 may be used. The clip 125 may be formed, for example, of plastic. The clip 125, according to some example embodiments, may include a holding portion 126 which may be a broad surface that, for example, has a shape and size that corresponds to the shape and size of the internal magnet cavity 120 (e.g., a circular shape) to retain the magnet 122 within the internal magnet cavity 120. The clip 125 may also include two legs 127 that extend from the holding portion 126, on opposite sides, in a direction, for example, that is substantially orthogonal to a surface of the holding portion 126. At an end of the each of the legs 127, an angled tab 128 may be disposed.

After the magnet 122 is placed in the internal magnet cavity 120, the clip 125 may be installed to secure the magnet 122 into the internal magnet cavity 120. The legs 127 of the clip 125 may be aligned with corresponding channels 129 on the interior wall of the internal magnet cavity 120. As the legs 127 are inserted into the channels 129, the angled tabs 128 may be compressed inward to generate a material biasing force in the external direction within the channels 129. As the angled tabs 128 travel along the channels 129 deeper into the internal magnet cavity 120, the angled tabs 128 may eventually engage respective voids (not shown) and lock into the voids due to biasing of the legs 127 toward the voids. With the angled tabs 128 locked into the voids of the channels 129, the clip 125 may be secured into place and the magnet 122 may, in turn, be secured within the internal magnet cavity 120. Securing the magnets 122 within the internal magnet cavity 120 may reduce or eliminate the risk of the magnets 122 being damaged if the battery charger 100 is dropped or otherwise jarred, since many rare-earth magnets may be brittle. Each magnet 122 may be secured within an internal magnet cavity 120 by a clip 125 according to some example embodiments.

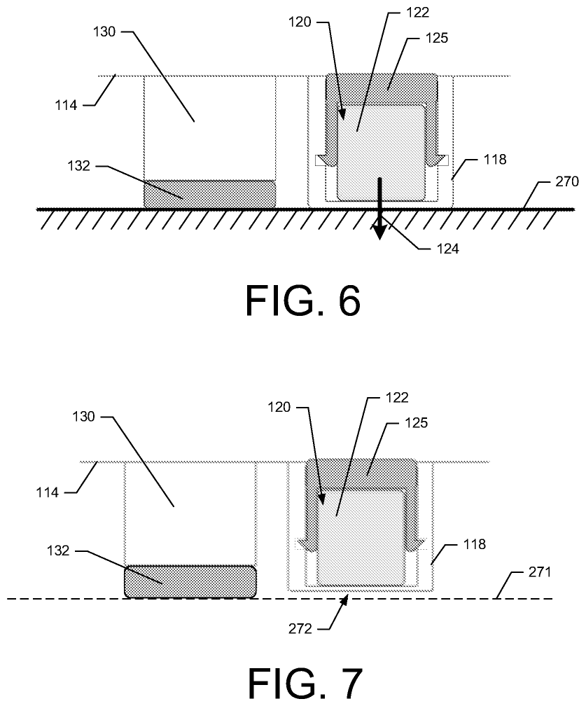

Now referring to FIG. 6, a cross-section of a foot 130 and a magnet protrusion 118 is shown in engagement with a surface 270. As shown in FIG. 6, the magnet 122, through the lower wall of the protrusion 118 in the base 114, may generate an attraction force indicated by arrow 124 with the surface 270, which may be a ferromagnetic surface. The attraction force 124 may urge the base 114 toward the surface 270 and place the pad 132 under compression. With the pad 132 under compression, a strong physical engagement between the pad 132 and the surface 270 may be created to ensure that a strong frictional force operates to maintain the foot 130 in position at the point of engagement with the surface 270. Additionally, due to the compression of the pad 132, the lower external surface of the protrusion 118 may move toward and, in some example embodiments, physically contact the surface 270. In this way, the magnet 122 may be disposed adjacent to the surface 270 (e.g., minimize the distance between the magnet 122 and the surface 270) to maximize the magnetic field from the magnet 122 that interacts with the surface 270. Additionally, according to some example embodiments, a distance between the base 114 (at the height from which the protrusion 118 extends) and the surface 270, with the pad 132 under compression, may be larger than a thickness of the power cord 154 to permit the power cord 154 to be disposed between the housing 110 and the surface 270 without impacting the engagement between the foot 130 or the protrusion 118 and the surface 270 when the power cord 154 is routed around the feet 130 and the protrusions 118.

FIG. 7 also shows a cross-section of a foot 130 and a magnet protrusion 118, however, when the foot 130 is not engaged with a surface. When a ferromagnetic surface is not present near the magnet 122, the attraction force 124 may also not be present. As such, the pad 132 may no longer be under compression and may be free to expand to an uncompressed thickness. In this configuration, the thickness of the pad 132 may cause the foot 130, due to the pad 132 being uncormpressed, to extend further from the base 114 than the lower external surface of the protrusion 118. The extension distance of the foot 130 with the pad 132 uncompressed is shown by line 271. As can be seen in FIG. 7, a gap 272 may exist between the lower external surface of the protrusion 118 and the line 271, when the pad 132 is not under compression. As such, this gap 272 facilitates the ability to form a strong physical engagement between the pad 132 and the surface 270, when the battery charger 100 is brought into contact with the surface 270, because the pad 132 has thickness that is available for compression. If this gap 272 was not present, according to some example embodiments, the protrusion 118 may be in contact with the surface 271 and the pad 132 may not be under compression, and thus a strong physical engagement between the pad 132 and the surface 270 may not be formed and the associated frictional forces.

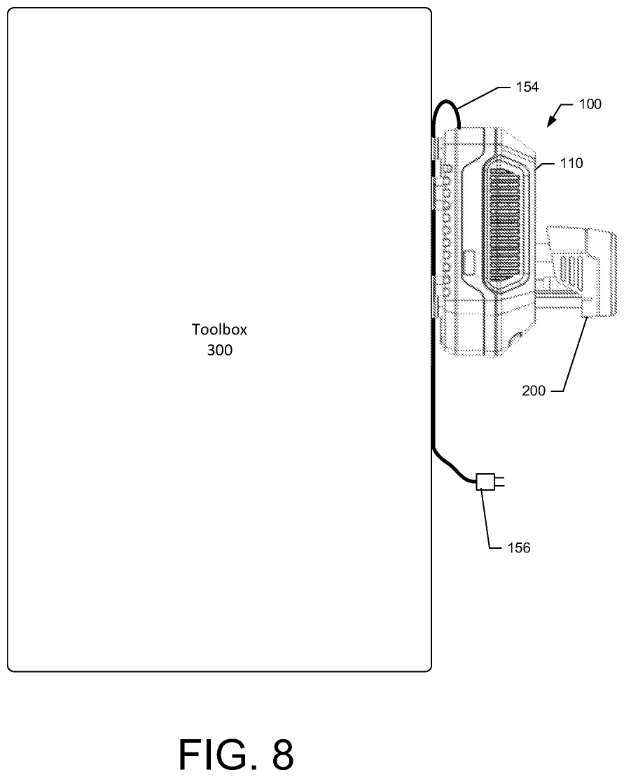

FIG. 8 illustrates an example application of a battery charger 100 to a side of a tool box 300, according to some example embodiments. As shown, the side of the tool box 300 may be a ferromagnetic surface and the battery charger 100, with the rechargeable battery 200 installed, may be secured to the side of the tool box 300 via the attraction forces created by the magnets 122 described above. Additionally, as shown in FIG. 8, the power cord 154 may be placed between the housing 110 and the surface of the tool box 300, without affecting the engagement between the feet 130 and the protrusions 118 and the surface of the tool box 300.

As such, according to some example embodiments, a battery charger is provided. The battery charger may comprise a housing, and the housing may comprise a base. The battery charger may further comprise battery charging electronics disposed within the housing. Additionally, the battery charger may comprise a first magnet disposed adjacent to the base on an internal side of the base and a second magnet disposed adjacent to the base on the internal side of the base. Magnetic fields of the first magnet and the second magnet may extend from the housing and away from the base to magnetically attract the base of the housing to a ferromagnetic surface to magnetically secure the battery charger to the ferromagnetic surface.

Additionally, according to some example embodiments, the battery charger may further comprise a first foot affixed to an external side of the base and a second foot affixed to an external side of the base. The first foot and the second foot may define a plane that passes between and is equidistant from the first foot and the second foot. The first magnet and the second magnet may be disposed at positions that intersect with the plane. Additionally, according to some example embodiments, the base may further comprise a key hole cavity configured to receive a screw head to hang the battery charger, the key hole cavity may be disposed at a position that intersects with the plane. Additionally or alternatively, according to some example embodiments, the base may comprise a first protrusion having a first internal cavity and a second protrusion having a second internal cavity. The first magnet may be disposed within the first cavity and the second magnet may be disposed in the second cavity. Additionally or alternatively, according to some example embodiments, the battery charger may further comprise a first foot extending from to an external side of the base and a second foot extending from an external side of the base. The first foot may comprise a first compressible pad and the second foot may comprise a second compressible pad. Additionally or alternatively, according to some example embodiments, when the battery charger is magnetically secured to the ferromagnetic surface, the magnetic fields may compress the first compressible pad and the second compressible pad a distance that causes the first protrusion and the second protrusion to physically contact the ferromagnetic surface. Additionally or alternatively, according to some example embodiments, when the first compressible pad and the second compressible pad are not compressed, according to some example embodiments, the first foot and the second foot may extend a distance from the base that is greater than height of the first protrusion and the second protrusion. Additionally or alternatively, according to some example embodiments, the battery charger may further comprise a power cord configured to deliver power to the battery charging electronics. A thickness of the power cord may be less than a height of the first protrusion and the second protrusion. Additionally or alternatively, according to some example embodiments, the battery charger may further comprise a first clip and a second clip. The first clip may be configured to engage with the first internal cavity to secure the first magnet within the first protrusion. The second clip may be configured to engage with the second internal cavity to secure the second magnet within the second protrusion. Additionally or alternatively, according to some example embodiments, the housing may further comprise a battery engagement side configured to engage with a rechargeable battery. The battery engagement side being dispose opposite the base of the housing.

According to some example embodiments, an apparatus is provided that comprises a housing. The housing may comprise a base and a cavity configured to receive a portion of a rechargeable battery that extends into the cavity. The apparatus may further comprise battery charging electronics disposed within the housing. The battery charging electronics may comprise a first contact and a second contact disposed within the cavity and configured to electrically connect with corresponding contacts of the rechargeable battery. Additionally, the apparatus may comprise a first magnet disposed adjacent to the base on an internal side of the base and a second magnet disposed adjacent to the base on the internal side of the base. Magnetic fields of the first magnet and the second magnet may extend from the housing and away from the base to magnetically attract the base to a ferromagnetic surface to magnetically secure the apparatus to the ferromagnetic surface.

Additionally or alternatively, according to some example embodiments, the apparatus may further comprise a first foot affixed to an external side of the base and a second foot affixed to an external side of the base. The first foot and the second foot may define a plane that passes between and is equidistant from the first foot and the second foot. The first magnet and the second magnet may be disposed at positions that intersect with the plane. Additionally or alternatively, according to some example embodiments, the base may further comprise a key hole cavity configured to receive a screw head to hang the apparatus. The key hole cavity may be disposed at a position that intersects with the plane. Additionally or alternatively, according to some example embodiments, the base may comprise a first protrusion having a first internal cavity and a second protrusion having a second internal cavity. The first magnet may be disposed within the first cavity and the second magnet may be disposed in the second cavity. Additionally or alternatively, according to some example embodiments, the apparatus may further comprise a first foot extending from an external side of the base and a second foot extending from an external side of the base. The first foot may comprise a first compressible pad and the second foot may comprise a second compressible pad. Additionally or alternatively, according to some example embodiments, when the apparatus is magnetically secured to the ferromagnetic surface, the magnetic fields may compress the first compressible pad and the second compressible pad a distance that causes the first protrusion and the second protrusion to physically contact the ferromagnetic surface. Additionally or alternatively, according to some example embodiments, when the first compressible pad and the second compressible pad are not compressed, the first foot and the second foot may extend a distance from the base that is greater than height of the first protrusion and the second protrusion. Additionally or alternatively, according to some example embodiments, the apparatus may further comprise a power cord configured to deliver power to the battery charging electronics. A thickness of the power cord may be less than a height of the first protrusion and the second protrusion. Additionally or alternatively, the apparatus may further comprise a first clip and a second clip. The first clip may be configured to engage with the first internal cavity to secure the first magnet within the first protrusion. The second clip may be configured to engage with the second internal cavity to secure the second magnet within the second protrusion. Additionally or alternatively, according to some example embodiments, the cavity in the housing may be disposed opposite the base of the housing.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A battery charger comprising:
a housing comprising a base;
battery charging electronics disposed within the housing;
a first magnet disposed adjacent to the base on an internal side of the base; and
a second magnet disposed adjacent to the base on the internal side of the base;
wherein magnetic fields of the first magnet and the second magnet extend from the housing and away from the base to magnetically attract the base of the housing to a ferromagnetic surface to magnetically secure the battery charger to the ferromagnetic surface.

2. The battery charger of claim 1 further comprising a first foot affixed to an external side of the base and a second foot affixed to an external side of the base;
wherein the first foot and the second foot define a plane that passes between and is equidistant from the first foot and the second foot;
wherein the first magnet and the second magnet are disposed at positions that intersect with the plane.

3. The battery charger of claim 2, wherein the base further comprises a key hole cavity configured to receive a screw head to hang the battery charger;
wherein the key hole cavity is disposed at a position that intersects with the plane.

4. The battery charger of claim 1, wherein the base comprises a first protrusion having a first internal cavity and a second protrusion having a second internal cavity;
wherein the first magnet is disposed within the first cavity and the second magnet is disposed in the second cavity.

5. The battery charger of claim 4, further comprising a first foot extending from an external side of the base and a second foot extending from an external side of the base;
wherein the first foot comprises a first compressible pad and the second foot comprises a second compressible pad.

6. The battery charger of claim 5, wherein when the battery charger is magnetically secured to the ferromagnetic surface, the magnetic fields compress the first compressible pad and the second compressible pad a distance that causes the first protrusion and the second protrusion to physically contact the ferromagnetic surface.

7. The battery charger of claim 5, wherein when the first compressible pad and the second compressible pad are not compressed, the first foot and the second foot extend a distance from the base that is greater than height of the first protrusion and the second protrusion.

8. The battery charger of claim 4 further comprising a power cord configured to deliver power to the battery charging electronics;
wherein a thickness of the power cord is less than a height of the first protrusion and the second protrusion.

9. The battery charger of claim 4 further comprising a first clip and a second clip;
wherein the first clip is configured to engage with the first internal cavity to secure the first magnet within the first protrusion; and
wherein the second clip is configured to engage with the second internal cavity to secure the second magnet within the second protrusion.

10. The battery charger of claim 1, wherein the housing further comprises a battery engagement side configured to engage with a rechargeable battery, the battery engagement side being dispose opposite the base of the housing.

11. An apparatus comprising:
a housing comprising a base and a cavity configured to receive a portion of a rechargeable battery that extends into the cavity;
battery charging electronics disposed within the housing, the battery charging electronics comprising a first contact and a second contact disposed within the cavity and configured to electrically connect with corresponding contacts of the rechargeable battery;
a first magnet disposed adjacent to the base on an internal side of the base; and
a second magnet disposed adjacent to the base on the internal side of the base;
wherein magnetic fields of the first magnet and the second magnet extend from the housing and away from the base to magnetically attract the base to a ferromagnetic surface to magnetically secure the apparatus to the ferromagnetic surface.

12. The apparatus of claim 11 further comprising a first foot affixed to an external side of the base and a second foot affixed to an external side of the base;
wherein the first foot and the second foot define a plane that passes between and is equidistant from the first foot and the second foot;
wherein the first magnet and the second magnet are disposed at positions that intersect with the plane.

13. The apparatus of claim 12, wherein the base further comprises a key hole cavity configured to receive a screw head to hang the apparatus;
wherein the key hole cavity is disposed at a position that intersects with the plane.

14. The apparatus of claim 11, wherein the base comprises a first protrusion having a first internal cavity and a second protrusion having a second internal cavity;
wherein the first magnet is disposed within the first cavity and the second magnet is disposed in the second cavity.

15. The apparatus of claim 14, further comprising a first foot extending from an external side of the base and a second foot extending from an external side of the base;
wherein the first foot comprises a first compressible pad and the second foot comprises a second compressible pad.

16. The apparatus of claim 15, wherein when the apparatus is magnetically secured to the ferromagnetic surface, the magnetic fields compress the first compressible pad and the second compressible pad a distance that causes the first protrusion and the second protrusion to physically contact the ferromagnetic surface.

17. The apparatus of claim 15, wherein when the first compressible pad and the second compressible pad are not compressed, the first foot and the second foot extend a distance from the base that is greater than height of the first protrusion and the second protrusion.

18. The apparatus of claim 14 further comprising a power cord configured to deliver power to the battery charging electronics;
wherein a thickness of the power cord is less than a height of the first protrusion and the second protrusion.

19. The apparatus of claim 14 further comprising a first clip and a second clip;
wherein the first clip is configured to engage with the first internal cavity to secure the first magnet within the first protrusion; and
wherein the second clip is configured to engage with the second internal cavity to secure the second magnet within the second protrusion.

20. The apparatus of claim 11, wherein the cavity in the housing is disposed opposite the base of the housing.
